(19) United States
(12) Patent Application Publication
(10) Pub. No.: US 2006/0163770 A1
(43) Pub. Date: Jul. 27, 2006

(54) Process for the manufacture of multicolor poured lipsticks and glosses

(75) Inventors: Renato Ancorotti, Crema (IT); Luigi Gandini, Cavenago di Brianza (IT)

Correspondence Address: NIXON & VANDERHYE, PC, 901 NORTH GLEBE ROAD, 11TH FLOOR, ARLINGTON, VA, 22203, US

(73) Assignee: GAMMA CROMA S.p.A., Milan (IT)

(21) Appl. No.: 10/562,693

(22) PCT Filed: Jun. 16, 2004
(86) PCT No.: PCT/IB04/01991

§ 371 Date: Feb. 7, 2006

(30) Foreign Application Priority Data
Jun. 27, 2003 (IT) MI2003AOO1317

(51) Int. Cl. B29C 39/12

(52) U.S. Cl. 264/152; 264/153; 264/245

(57) ABSTRACT

Coloured lipstick and gloss of the flat palette type are produced according to a method which comprises the following steps: pour a first and second material with different colours into different moulds; punch at least one portion of said materials; remove the punched portions from the respective moulds and deposit them in a packaging container, the shapes of the portions of the first and second material being complementary to substantially cover all the part of interest of said packaging container.

The present invention concerns a process for the manufacture of multicolor lipstick and gloss. More in particular, the invention concerns a process and a device for the manufacture of multicolor lipstick and gloss of the palette type, housed in a container and provided with portions of different shapes and colours.

### BACKGROUND OF THE INVENTION

Lipsticks and glosses differ basically due to the fact that lipsticks have a greater covering action than glosses. In addition to the stick form, lipsticks and glosses are also available in a flat format, so called “poured”, and can be applied to the lips by means of equipment such as flock application devices and similar.

Lipsticks and glosses of the poured type are available on the market consisting of two or more portions having different colours; in general the container is filled with the basic colour except for one or more portions with different colours. These differently coloured portions are generally shaped to give the product greater appeal.

This type of product, however, has the disadvantage that the differently coloured portions have an irregular level, different from that of the basic portion: they are concave in the central part and often have a raised irregular outer edge, in contact with the basic portion.

### SUMMARY OF THE INVENTION

The aim of the present invention is to solve the above problem and produce lipsticks and glosses in which different portions each have a uniform level throughout and in which, possibly, different portions have the same level as each other.

### DETAILED DESCRIPTION OF THE INVENTION

This aim is achieved by means of the present invention which concerns a method for the manufacture of coloured lipsticks and glosses of the poured type, characterised in that it comprises the following steps:

pour a first material having a first colour into a first mould and pour at least one second material having a second colour into a second mould;

punch at least one portion of said first material;

punch at least one portion of said at least one second material;

remove said portion of said first material and said portion of said at least one second material from the respective moulds;

deposit said portions of the first and the at least one second material in a packaging container, the shapes of said portions of the first and the at least one second material being complementary to each other to substantially cover all the part involved in said packaging container.

According to a preferred embodiment, the method provides for punching and removal from the first material of a portion having a shape corresponding to a portion not removed from said mould of the second material, and so on for any further portions not removed. In this way a portion of basic colour is obtained consisting of the portions of second colour, with a plurality of coloured portions housed in the portions missing in said basic colour.

According to an alternative embodiment, the method provides for arrangement side by side in the packaging container referred to of the portions of material punched and removed from the moulds. This will produce an end product configuration in which a basic colour is not present but several different portions beside each other.

A further aim of the invention is a multicolor lipstick or gloss as can be obtained with a process according to the above description, characterised in that each portion of material has a uniform thickness.

Preferably the same thickness is given to all the portions of material present, thus obtaining a uniform thickness inside each portion and for all the multicolor end product.

The present invention has numerous advantages with respect to the previously known technique since, in addition to producing a product with improved appearance, it reduces manufacture costs thanks to the substantial absence of manufacture scrap and reduction of working times.

The invention will now be described in greater detail with reference to the drawings attached for illustrative and non-limitative purposes, where:

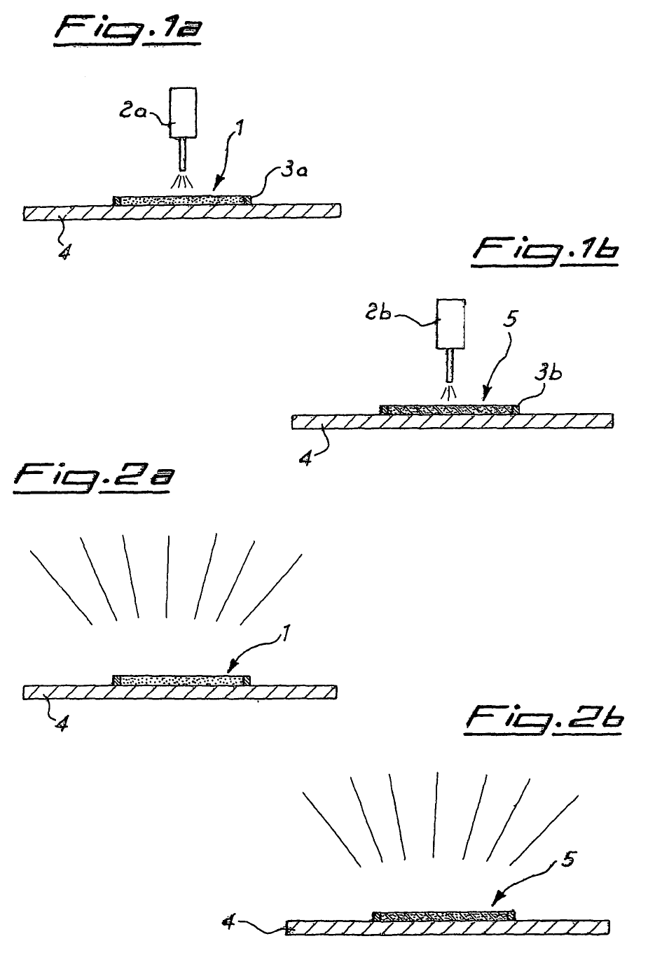

FIGS. 1-6 are schematic section views of the manufacture steps of lipstick and gloss according to the invention; and

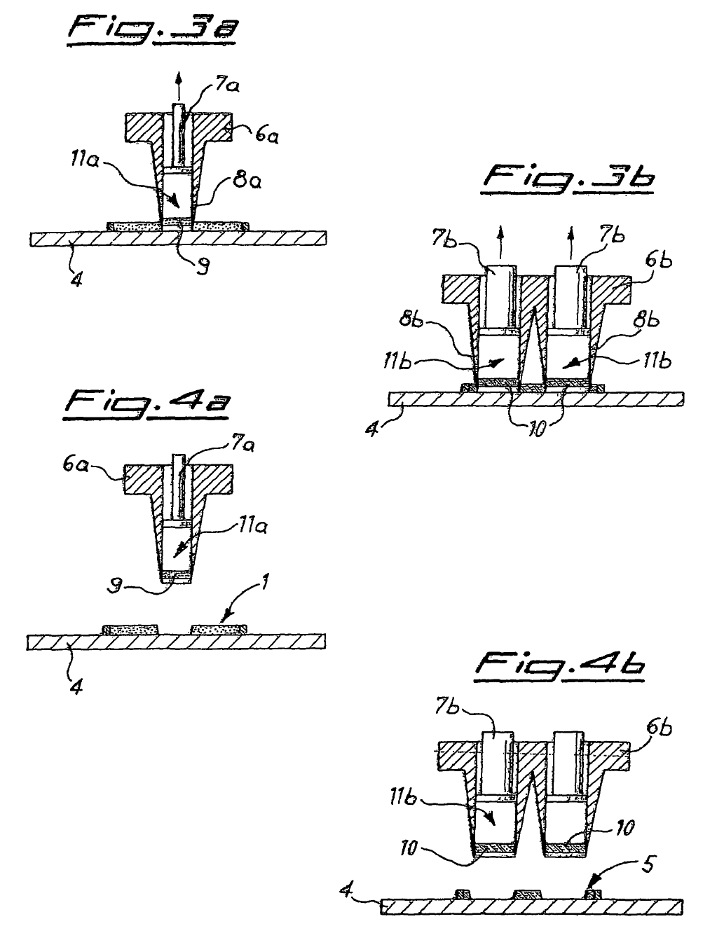

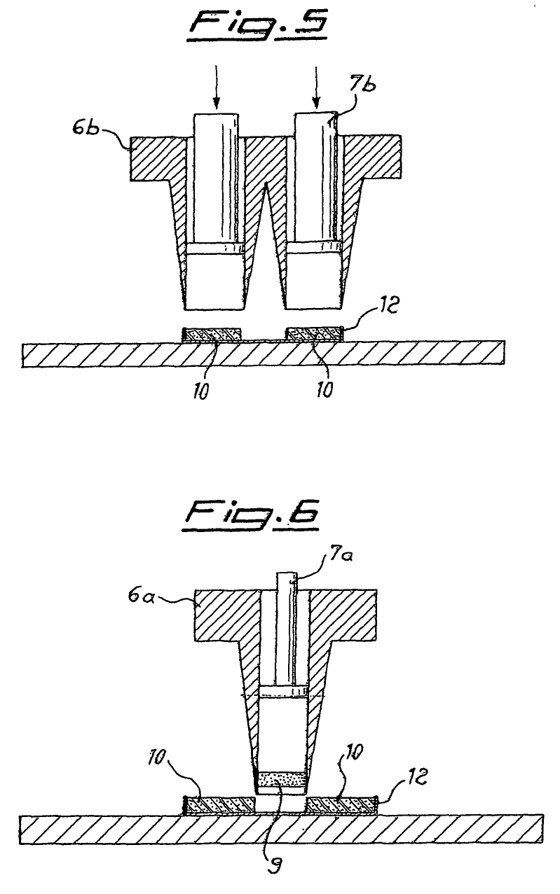

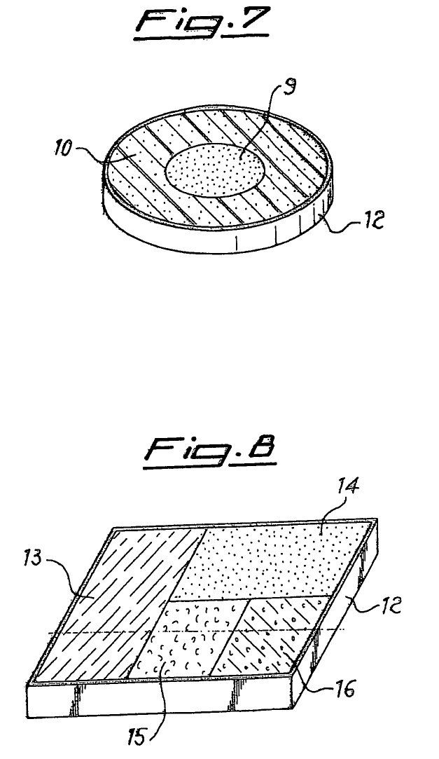

FIGS. 7 and 8 are schematic and perspective views of the product obtained according to the invention.

The process according to the present invention provides basically for the punching of portions of complementary lipstick or gloss material and arrangement of them in a packaging container in which they fill the entire area of the same.

Material for lipstick or gloss indicates one of the materials known and commonly used for said products.

Packaging container indicates a container such as a case, plate or tray which can be the end container or can be inserted in turn into an end container for sale.

The term area involved in the packaging container indicates the whole area that must be covered by the portions of material, i.e. the portions of material cover said area (in general the whole container) without leaving substantial spaces, i.e. gaps, between one punched portion and another.

With reference to FIGS. 1a and 1b, the process initially provides for pouring of a product 1 having a first colour from a metering unit 2a into a mould 3a. The mould 3a rests on a base 4 made of silicone or similar material with reduced adhesion and able to withstand a punching operation.

Similarly, a second material 5 having a second colour is poured from the metering unit 2b into a mould 3b resting on the base referred to 4, similar to the one shown in FIG. 1a. The products poured in form layers which are left to cool and solidify (FIG. 2a and 2b).

The next step is shown in FIGS. 3a and 3b and provides for punching at least one portion of the layer of material 1 and at least one portion of the layer of material 5. In the embodiment illustrated one portion 9 of the layer of the first material 1 and one ring-shaped portion 10 of the layer of the second material 5 are punched by means of respective punches 6a and 6b. These punches are of known type in the technique of manufacture and processing of cosmetic products and are provided with one or more punching chambers 11a and 11b which extend upwards and form housings for corresponding pistons 7a and 7b. The pistons 7a and 7b are mobile to create an underpressure when they move upwards in the direction of the arrow in FIG. 3a and 3b, and a pressure when they move downwards, in the opposite direction to said arrow.

In fact, after punching, the pistons are moved upwards by a distance sufficient to raise and detach the portions 10 and 11 (cf. FIG. 3a and 3b) in the housings 11a and 11b from the remaining layer of first material 1 and second material 5.

At this point the portions 9 and 10 are removed from the layers 1 and 5 (FIG. 4a and 4b) and deposited (FIG. 5 and 6) in a packaging container 12 moving the pistons 7a and 7b downwards. As can be seen in FIGS. 5 and 6, the outer portions 10 are deposited first and then the inner portion 9. The shapes and areas of the portions 9 and 10 are complementary and such as to cover the whole area of the container 12.

FIG. 7 shows a view of the final result after depositing of the portions 9 and 10 in the packaging container 12.

FIG. 8 shows an embodiment in which the punched portions 13-16 are deposited side by side but not inserted one in the other as in the embodiment of FIG. 7. Various types of shape are obviously possible as several portions 9 can be inserted in the basic portion 10; furthermore it is possible to combine different materials, i.e. have a portion of material for gloss and one or more portion of material for lipstick.

Preferably the portions 9 and 10 or 13-16 all have basically the same thickness and therefore the end product has a uniform thickness throughout the container, but it is possible to have portions with different thicknesses as long as the thickness of each portion is uniform.

1. Method for the manufacture of coloured lipstick and gloss of the poured type, characterised in that it comprises the following steps:
pour a first material having a first colour into a first mould and pour at least one second material having a second colour into a second mould;
punch at least one portion of said first material;
punch at least one portion of said at least one second material;
remove said portion of said first material and said portion of said at least one second material from the respective moulds;
deposit said portions of the first and the at least one second material in a packaging container, the shapes of said portions of the first and the at least one second material being complementary to each other to substantially cover all the part involved in said packaging container.

2. Method according to claim 1, characterised in that of punching and removing from said first material a portion having a shape corresponding to a portion not removed from said mould of the second material.

3. Method according to claim 2, characterised in that of punching and removing from a plurality of materials a plurality of shapes corresponding to a plurality of portions punched but not removed from said mould of said second material.

4. Method according to claim 1, characterised in that of arranging side by side in the above-mentioned packaging container said portions of material punched and removed from said moulds.

5. Method according to claim 1, characterised by the fact of giving the same thickness to said first and at least one second material.

6. Multicolor lipstick or gloss obtainable by a process according to claim 1, characterised in that each portion of material has a uniform thickness.

7. Multicolor lipstick or gloss according to claim 6, characterised in that the thickness of all the portions of material in the packaging container is substantially the same.
